(19) United States
(12) Patent Application Publication
(10) Pub. No.: US 2023/0302374 A1
(43) Pub. Date: Sep. 28, 2023

(54) ENTERTAINMENT SYSTEM FOR A VEHICLE

(71) Applicant: DISNEY ENTERPRISES, INC., Burbank, CA (US)

(72) Inventors: Matthew Deuel, Playa Vista, CA (US); Steven M. Chapman, Newbury Park, CA (US); Joseph Mohos, Burbank, CA (US)

(21) Appl. No.: 17/702,998

(22) Filed: Mar. 24, 2022

(51) Int. Cl. A63G 31/16; A63G 31/02; B60L 53/30; B60L 53/66; B60L 53/16; B25J 11/00; B60K 35/00

(52) U.S. Cl. CPC A63G 31/16; A63G 31/02; B60L 53/30; B60L 53/66; B60L 53/16; B25J 11/003; B60K 35/00; B60L 2250/16; B60K 2370/177; B60K 2370/58; B60K 2370/73

(57) ABSTRACT

The present disclosure relates to an entertainment system for a vehicle. In one embodiment, the entertainment system includes a display external to the vehicle and viewable by an occupant of the vehicle. The entertainment system includes a communication module to receive occupant preferences from an occupant, and a processor configured to generate or modify content to be presented on the display based on the occupant preferences.

### TECHNICAL FIELD

Systems and methods providing entertainment systems for use with a vehicle.

### BACKGROUND

Onboard computing and infotainment capabilities of vehicles have become increasingly sophisticated. Yet the content presented by such systems remains limited to in-dash or other internal screens and audio systems which necessarily limit the immersiveness of the experience. For example, while an in-vehicle infotainment system may play a movie, an occupant need only look out the window and see the real-world outside of the movie breaking the immersion in the media. Further exacerbating the problem, electric vehicles may need long periods of non-driving time to charge. During such times, occupants may find themselves in their vehicles, not driving, and with little to do while the vehicle charges. In some cases, charge times can be on the order of several hours. The problem is not limited to electric vehicles; conventional combustion-driven vehicles may be idle for long periods of time as well (e.g., during service, waiting for meal delivery, etc.). Currently, there is no way to provide immersive entertainment to the occupants of the vehicle during such periods of non-driving time. Improved methods and systems of providing content to vehicle occupants are needed.

### BRIEF SUMMARY

An entertainment system for a vehicle is disclosed. In one embodiment, the entertainment includes a display external to the vehicle and viewable by an occupant of the vehicle; a communication module configured to receive occupant preferences from the occupant; and a processing element configured to generate or modify content to be presented on the display based on the occupant preferences.

Optionally, in some embodiments, the entertainment system includes a structure configured to receive the vehicle; and a charging device configured to charge the vehicle. The display is coupled to the structure and is configured to present the content to the occupant as the charging device charges the vehicle.

Optionally, in some embodiments, the display substantially surrounds the vehicle.

Optionally, in some embodiments, the communication module receives data via a vehicle cable or wireless communication.

Optionally, in some embodiments, the entertainment system includes a sense effect system configured to provide at least one of a smell effect, a sound effect, a heat effect, a cold effect, a wind effect, or a weather effect.

Optionally, in some embodiments, the entertainment system includes an animatronic device configured to present a portion of content.

Optionally, in some embodiments, the animatronic device is configured to electrically couple the charging device to the vehicle.

Optionally, in some embodiments, the entertainment system includes a base configured to support the vehicle and to provide at least one of a tilt effect, an acceleration effect, a deceleration effect, or a haptic effect to the vehicle.

Optionally, in some embodiments, the entertainment system includes an auxiliary autonomous vehicle configured to present a portion of the content.

Optionally, in some embodiments, the auxiliary autonomous vehicle includes at least one of an autonomous aerial vehicle, an autonomous ground-based vehicle, or a robot.

Optionally, in some embodiments, the entertainment system includes a communication system in electrical communication with a control system of the vehicle. The communication system is configured to transmit a signal to the vehicle, and based on the signal, the control system is configured to present a portion of the content.

Optionally, in some embodiments, the communication system is configured to activate a portion of the control system in synchronization with the content.

Optionally, in some embodiments, the control system is configured to receive an input from the occupant, wherein the input causes a change in the content.

Optionally, in some embodiments, the entertainment system is configured to communicate electronically with an onboard diagnostic II (“OBD-II”) interface of the vehicle. In some embodiment, the entertainment system includes an OBD-II device configured to provide the electrical communication between the communication system and the control system.

Optionally, in some embodiments, the content is configurable by an occupant device.

Optionally, in some embodiments, the entertainment system the content comprises a game or a puzzle.

Optionally, in some embodiments, a system includes two or more entertainment systems, where the content comprises a game configured to enable occupants of respective vehicles received in the two or more entertainment systems to participate together.

In some embodiments, the entertainment system includes one or more processing elements; one or more computer-readable non-transitory storage media, the media encoded with instructions that when executed cause the one or more processing elements to perform operations including: displaying content on a display external to the vehicle and viewable by an occupant of the vehicle; receiving occupant preferences from the occupant; modifying the content based on the occupant preferences; and displaying the modified content.

A method of providing content to a vehicle is disclosed. In one embodiment, the method includes displaying, via one or more processing elements, content on a display external to the vehicle and viewable by an occupant of the vehicle; receiving, via the one or more processing elements, occupant preferences from the occupant; modifying, via the one or more processing elements, the content based on the occupant preferences to generate modified content; and displaying, via the one or more processing elements, the modified content.

An entertainment system for a vehicle is disclosed. In one embodiment, the entertainment system includes a display external to the vehicle and viewable by an occupant of the vehicle; a show control system coupled to the display to control content presented on the display, and coupled to an in-vehicle control system to control at least one vehicle system; and a processing element configured to generate or modify content to be presented on the display to coordinate the content with the at least one vehicle system.

### BRIEF DESCRIPTION OF THE SEVERAL VIEWS OF THE DRAWINGS

FIG. 1 is a perspective view of an example of a plurality of entertainment systems.

FIG. 2 is a perspective view of the entertainment system of FIG. 1 including a vehicle entering into the entertainment system.

FIG. 3 is a perspective view of an example of an interior portion of the entertainment system of FIG. 1 with a vehicle positioned therein.

FIG. 4 is a perspective view of an example of an interior portion of the entertainment system of FIG. 1 including a vehicle experiencing media content.

FIG. 5 is an interior view of a portion of an example of a control system of the vehicle in use with the entertainment system of FIG. 1.

FIG. 6 illustrates an example of components of the entertainment system of FIG. 1.

### DETAILED DESCRIPTION

The present disclosure provides for entertainment systems particularly for use with a vehicle such as an on-road passenger vehicle. The disclosed systems, and related methods, include a display external to the vehicle and visible to occupants or users of the vehicle. As used herein, the terms occupants and users are interchangeable. The entertainment systems integrate with the vehicle, such as integrating with a control system and/or operatively coupling to provide control inputs to the control system (e.g., an infotainment system, drive system, climate control system, security system, etc.), to extend the presentation of content to the interior of the vehicle to create an immersive experience. As used herein, content is any kind of visual, auditory, motion, smell, weather, light, heat, cold, or other sensory effect generated by the entertainment system 100. Relatedly, presentation of content includes, but is not limited to, display of visual information, effects, and/or lighting as well as generation of sounds, smells, motion effects (e.g. haptics, tilt, acceleration, etc.), weather effects, heat or cold effects, or any other sensory effect, etc. The content may include a story telling, narrative, or plot aspect which may be supported or augmented by the sensory effects. For example, a portion of the content may be presented or generated by the external display (e.g., outside of the vehicle), and/or other external systems, and a portion of the content may be presented internal or within the vehicle systems (e.g., inside the vehicle), wherein the internal vehicle presentation may be correlated or connected with the external presentation. The external and internal content elements may be presented in synchronization or otherwise correlated or coordinated with one another. The entertainment system may also include systems to generate content elements, such as effects, e.g., sound, haptics, light, smell, weather effects (e.g., rain, wind, snow, fog, etc.). In some examples, a wind effect may include air moved within the internal compartment 190, such as by a fan, blower, compressed air source, or the like. In some examples a wind effect may be combined with a cold effect (e.g., a cool breeze after a simulated rain storm) or a heat effect (e.g., a blast of hot air in a desert simulation).

In one example, the entertainment system may present an interactive simulation where the vehicle temporarily becomes an integral part of the simulation or experience. For example, a passenger car is not usually integrated with an interactive simulation, but may temporarily become a part of a simulation through the entertainment system. Content may be presented on the external display, and information related to the content may be presented on an internal display of the vehicle. The vehicle control system may be configured to receive an input from the vehicle occupant such that the input alters or otherwise impacts the content 134. For example, the content 134 may change based on one or more user actions or user interactivity. For example, the content may be a game and the vehicle driving controls (e.g., steering wheel, brake pedal, accelerator pedal, etc.) may be used to provide inputs to the game, e.g., act as controls for the user's character within the game. The vehicle's controls may be used to provide feedback to the simulation such that the simulation becomes an interactive experience with the vehicle as an integral part thereof. In other words, the vehicle may act as a feature within the content, act to generate sensory experiences for the user with the content, and/or provide user input to more deeply engage with the content. To facilitate such interactive functionality, the entertainment system and the vehicle may be in communication with one another (using wired, wireless, optical, infrared, sonic and/or other available communication technology). In some examples, the communication between the entertainment system and the vehicle may include an application programming interface (“API”) that enables communication between the entertainment system and the vehicle.

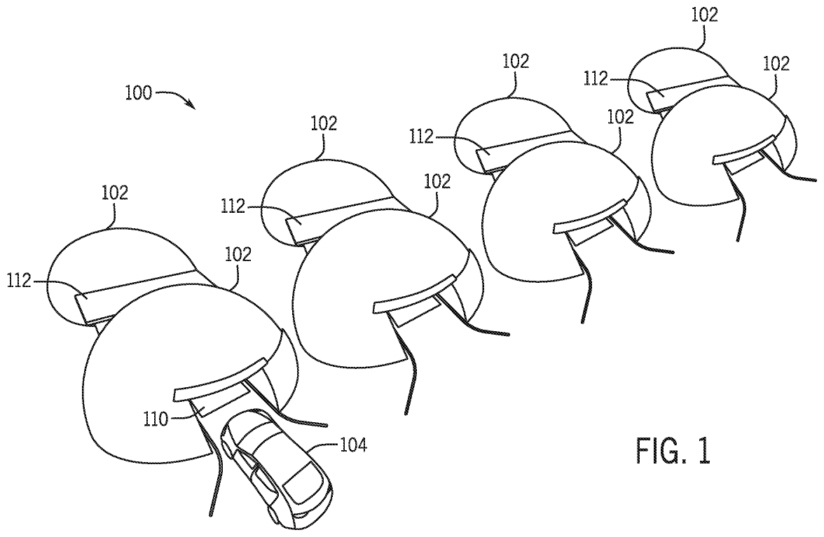

With specific reference to FIG. 1, an example of an entertainment system 100 is shown. The entertainment system 100 includes a structure 102 suitable to receive a vehicle 104 either partially or fully therein. In many examples, the vehicle 104 is an autonomous or semi-autonomous vehicle, e.g., may include a self-driving feature or functionality. However, some examples of the entertainment system 100 may be suitable for use with traditionally user-driven vehicles. In many examples, the vehicle 104 is an electric vehicle. In some examples, the vehicle 104 is a hybrid or traditional internal combustion powered vehicle. In FIG. 1, multiple entertainment systems 100 are shown. For example, two or more entertainment systems 100 may be placed close to one another for use with multiple vehicles 104. For example, two or more entertainment systems 100 may be placed in proximity to one another to form a cluster of entertainment systems 100, such as to provide entertainment for multiple vehicles.

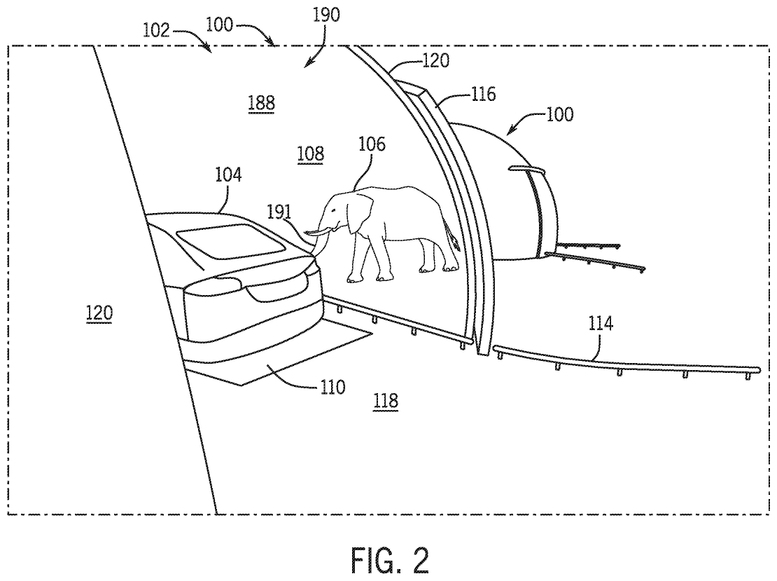

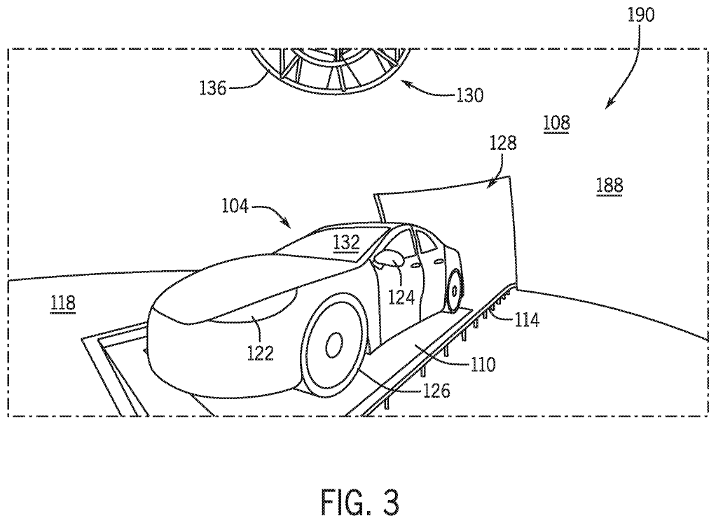

With specific reference to FIGS. 2 and 3, in the example shown, the structure 102 or enclosure is a dome-like structure formed by one or more walls 120. The internal surface 188 of the walls 120 of the structure 102 may form an internal compartment 190 or entertainment environment within which portions of the content may be presented. The compartment 190 may form an immersive environment in which the vehicle 104 is received and within which portions of the content are presented to be experienced by occupants of the vehicle 104. In some examples, the structure 102 allows containment of the vehicle 104 in the compartment 190, control of the sensory experience in the compartment (e.g., sound, lights, weather and the like), and can partially enclose or substantially enclose the vehicle to have a 360° or other immersive display and experience. The structure 102, and in particular the high sides and top may help ensure that from any viewing location within the vehicle (e.g., through a sunroof) the experience is not disrupted by the real world. In other examples, the structure 102 may be any other suitable size and/or shape to accept a vehicle 104 or present content 134 to occupants of a vehicle 104. While the examples of the structures 102 shown are sufficiently large to enclose a vehicle 104, other structures 102 may be used that can partially enclose a vehicle 104, or may not enclose the vehicle at all. In some examples, the structure 102 is a collapsible structure that can be quickly deployed to a location and may be redeployed with ease. For example, the structure 102 may have a frame/membrane form similar to a tent. In some examples, the structure 102 is a more durable structure formed of traditional construction materials such as metal, concrete, wood, or the like. In some examples, the entertainment system 100 includes a power supply 172 such as a photovoltaic panel 112 (see, e.g., FIG. 1) that at least partially provides power to the entertainment system 100 and or the vehicle 104. Other power supplies 172 such as generators, mains connections, batteries, or the like may be used.

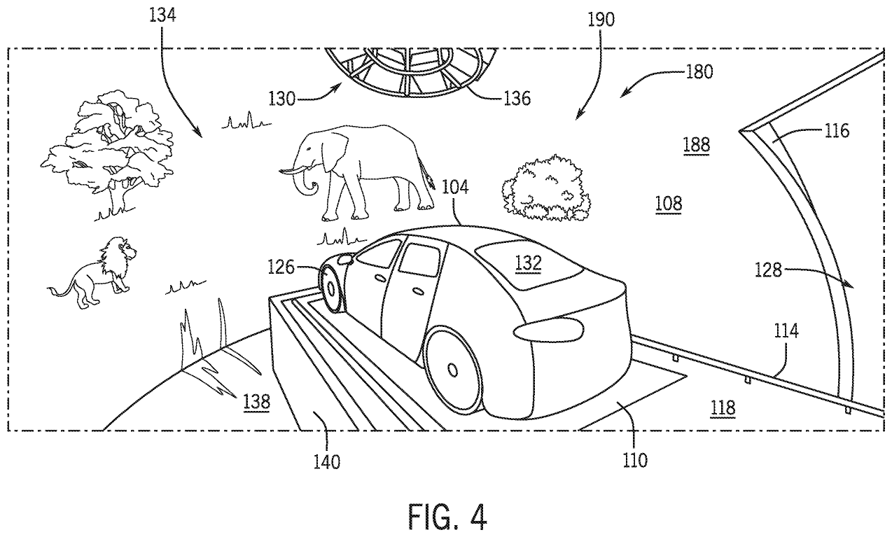

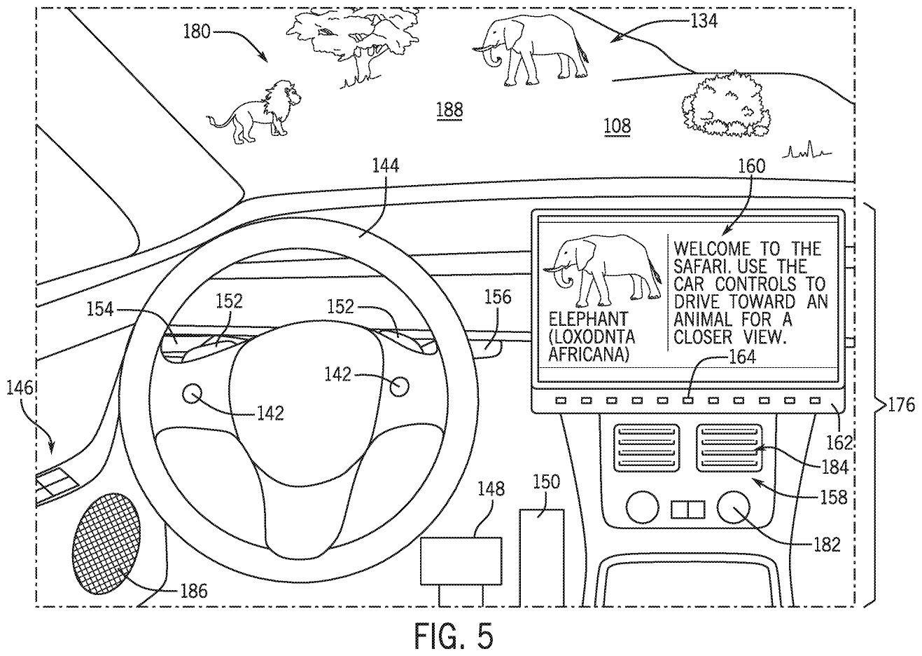

The structure 102 may include a support surface 118 such as a driveway, track, or floor that enables a vehicle 104 to drive (in the case of an autonomous vehicle) or be driven (in the case of autonomous, semi-autonomous, or traditional human-operated vehicles) through an aperture 128 in the structure 102. For example, a user may select or purchase content 134 (see, e.g., FIGS. 4 and 5) from a list of available content and place the vehicle 104 in electronic communication with the entertainment system 100, and the vehicle 104 may drive itself or be driven into the structure 102. In some examples, the driver of the vehicle 104 may navigate the vehicle 104 into the structure 102 and the entertainment system 100 may prompt the driver (e.g., visually and/or audibly) when to stop. The support surface 118 may have a stop 114 disposed on a portion of a perimeter thereof. The stop 114 may guide the vehicle 104 into the structure 102 and/or through the aperture 128. The stop 114 may reduce the ability of a vehicle 104 to move too far into the structure 102. The stop 114 may reduce the ability of occupants of the vehicle 104 to exit the vehicle 104 and enter portions of the structure 102 with access restrictions. The aperture 128 may be a doorway, tunnel, passage, or the like suitable large to receive the vehicle 104. The aperture 128 may be selectively closeable such as by a door 116, screen, or the like to enable an enclosed experience if desired. In the example shown, the door 116 is of a suitable shape such that when closed, the door 116 and the dome structure 102 appear from an occupant of the vehicle 104 to be seamless.

The support surface 118 may include or be adjacent to a base 110 that supports one or more wheels 126 of the vehicle 104. The vehicle 104 may be driven onto the base 110 from the support surface 118. The base 110 may be a static floor, or may be an active surface that can tilt, vibrate, accelerate, decelerate, move, translate (e.g., on a moving belt of sliding carriage), or otherwise apply forces to the vehicle 104. For example, the base 110 may provide a haptic effect to the vehicle 104 such as rumbling, knocking, jolting, acceleration, deceleration, pitch, roll, heave, spin or the like.

In some examples, the entertainment system 100 may include a charging device 106. The charging device 106 may be disguised as a themed prop. See, e.g., FIG. 2, where the charging device is disguised as an elephant with the cable 191 disguised as the elephant's trunk. The charging device 106 may be any suitable device capable of charging the onboard energy storage of the vehicle 104, such as an electric vehicle. For example, the charging device 106 may have a cable 191 that can carry power and/or data between the vehicle 104 and the entertainment system 100. The charging device 106 may provide a communications link between the vehicle 104 and the entertainment system 100 via the cable 191. In some embodiments, such as where the vehicle is not an electric vehicle, the cable 191 provides a communications link but does not charge the vehicle. The charging device 106 may be any form of Electric Vehicle Supply Equipment (“EVSE”) suitable to charge a vehicle 104. For example, the charging device 106 may be a level 1, level 2, or level 3 (e.g., direct current fast charge) EVSE device as defined for example in the National Electrical Code Handbook (e.g., NEC-1999). Society of Automotive Engineers standard J1772 defines general physical, electrical, communication and performance requirements for EVSE used in North America, and is incorporated herein by reference in the entirety. EVSE standards to other areas than North America are applicable to the charging device 106 as well. In some embodiments, the charging device 106 is a proprietary type of EVSE such as a Tesla® or Rivian® charger, or the like. In some examples, the charging device 106 is an inductive charger disposed on the support surface 118 or the base 110.

The charging device 106 may have features that enable it to blend with or supplement the content 134. For example, the charging device 106 may include features of a character or scenery related to the content 134. The charging device 106 can have mechanical and/or physical characteristics that allow the charging device 106 to mimic portions of the content. The charging device 106 may also be configured to include dynamic display areas that allow content to be displayed thereon (e.g., a display screen integrated with the charging device 106). In the example shown in FIG. 2, the charging device 106 includes features that make it appear to be an elephant and the cable 191 may appear to be its trunk. In some examples, the charging device 106 includes an animatronic character that can present a portion of the content 134. In some examples, the animatronic character may make a physical electric connection between the charging device 106 and the vehicle 104, such as plugging in the cable 191.

The charging device 106 can provide power to the vehicle 104, e.g., include a plug or connector that couples to the vehicle and connects the vehicle to a power supply to transfer power therebetween. The charging device 106 may interface between the respective communication modules 170 of the vehicle 104 and the entertainment system 100, such as via the cable 191.

The structure 102 may have a display system 130. The display system 130 presents a visual component of at least a portion of content 134 (see, e.g., FIG. 4). The display system 130 may include an external display 108 such as a screen, projection surface (either rear projection or forward projection), scrim, half-mirror film, or the like that displays a visual components of the content 134. In some examples, the internal surface 188 of the structure 102 may include a projection surface, a display or type of material/color to enable content presentation thereon (either by a projector 136, displays, and/or light sources integrated with the structure 102). In some examples, a substantial portion of the internal surface 188 may include a projection surface. In the example shown, the display system 130 includes one or more projectors 136. The projectors 136 may be disposed on an upper interior portion of the structure 102 such that the projectors 136 can display content 134 on the external display 108 and/or internal surface 188 of the structure 102. In some examples, the projection surface may be retractable and may be deployed when the vehicle 104 is in the appropriate location, such as parked in the structure 102. The external display 108 may be a projection surface such as a reflective screen where the projector 136 is positioned to project light on a front side (e.g., side facing the occupants of the vehicle 104) of the projection surface. In other examples, the external display 108 may be at least partially transparent, translucent or diffusive such that the projector 136 projects a visual component of the content 134 on the rear side of the projection surface (e.g., side facing away from the occupants of the vehicle 104) part of which passes through the external display 108 toward an occupant of the vehicle 104. In other examples, the external display 108 may be a liquid crystal display, light emitting diode display (“LED”), organic LED (“OLED”) display, digital light processor, combinations of the same, or the like. In other examples, external display 108 may be transparent such as glass, plastic or film configured as a half-mirror to reflect light from structure 102 or physical props (not shown) illuminated by light from structure 102 in a Pepper's Ghost or similar configuration.

In the example shown, the projectors 136 may be 2D, stereoscopic or holographic, laser, digital light processor, LCD, LED, or other types of projectors to display the visual portion of the content 134 on the external display 108 in a manner to substantially surround the vehicle 104. For example, the projectors 136 may each display a portion of the visual component of the content 134 such that the portions of the respective projectors 136 tile or overlap to create a seamless visual presentation. Some of projectors 136 may be actuated to move in one or more degrees of freedom under programmatic control so that projected images move across projection surfaces 108 and 118. Further, some light from projectors 136 may be optically coupled via mirrors (not shown) to projection surfaces 108/118 to, for example, hide projectors 136, place projectors 136 in more secure locations, and/or increase the focal length of the projection system to enhance depth effects.

As shown for example in FIG. 4, the external display 108 may extend below a portion of the vehicle 104. The support surface 118 and the base 110 (if used) may form a platform 140 disposed above a floor 138 of the structure 102. Thus, the display system 130 may display content 134 below the horizon as seen from the point of view of the occupant of the vehicle 104. A benefit of such an arrangement may be more complete immersion of the occupants of the vehicle 104 in the content 134. Another benefit may be that the space between the vehicle 104 and the floor 138 may provide a location for effect generators such as animatronics, lights, weather simulators, or the like to be placed when not in use and out of sight of the vehicle 104 occupants.

With reference to FIG. 5, an example of a vehicle interior 158 of a vehicle 104 is shown. The vehicle interior 158 shows certain components of the control system 176 of the vehicle 104. The control system 176 may include one or more of an audio system 186, a vehicle light 122 (shown for example in FIG. 2 as an exterior light but may also be an interior vehicle light, not illustrated), a heads-up display on a windshield 132, an internal display 162 such as a touch screen, a windshield wiper control 156, a powertrain, an operator control 142, a steering wheel 144, a window control 146, a mirror 124 control, a moon roof control, a brake control 148, an accelerator 150, a shifter control 152, a vehicle climate control 182, a vehicle infotainment system, a door actuator, a trunk actuator, a seat heater, a seat cooler, a seat massage device, a seat positioner, a clutch, or the like. The control system can control operation, and/or receive input from, these elements.

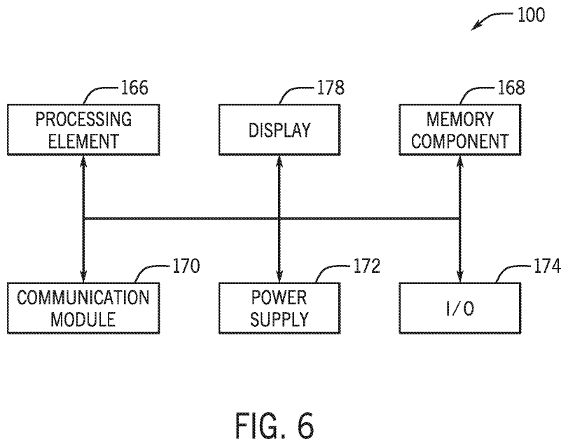

FIG. 5 is an example view of the external display 108 from the point of view of an occupant of the vehicle 104. The entertainment system 100 may include any number or combination of effect generators, such as the display system 130, lights, a sense effect system including such devices as air movers, sprayers, scent emitters, motion actuators, haptic actuators, sound generators, animatronics, and/or an auxiliary autonomous vehicle (e.g., an aerial or ground-based drone, robot, or the like), or the like. These can be dispersed within the entertainment environment of the internal compartment 190. In some examples, the content 134 includes an interior portion 160 presented in the vehicle 104 and/or by a portion of the vehicle 104 (e.g., a portion of the control system 176), and an exterior portion 180 presented outside the vehicle 104 by a portion of the entertainment system 100. Correspondingly, the exterior portion 180 of the content 134 may include any combination or number of effects including audio effects, haptic effects, vehicle motion effects, lighting effects, smell effects, weather effects (e.g., heat, cold, wind, rain, snow, fog, or the like). In the example of FIGS. 5 and 6, a visual effect of an exterior portion 180 of the content 134 is viewable on the external display 108 by an occupant of the vehicle 104. The effects generated by the entertainment system 100 may form a cohesive entertainment experience.

In some examples, a portion of the content 134 may be presented on a virtual reality display, augmented reality display (e.g., a head mounted display or augmented reality glasses) (“AR/VR display”). In some examples, a user using an AR/VR display may see an object or structure of the vehicle (e.g., steering wheel 144), the entertainment system (e.g., a prop), or a portion of the media 134 transform such that one or more properties of the object changes, or the object transforms into some other object. For example, the AR/VR display may present an animation of the steering wheel 144 transforming into a different design, such as a different color/shape for buttons. The AR/VR display may display instructions describing the new function of the button. For example, a button 142 may appear to change from an audio track select button on the steering wheel 144 into a button that causes the entertainment system 100 to display content 134 showing a tranquilizer dart being shot toward a charging lion.

The entertainment system 100 communicates with the vehicle 104, and vice versa, to present the content 134. For example, the entertainment system 100 may communicate an interior portion 160 of the content 134 to the vehicle 104 for presentation via the control system 176. The activation of the control system 176 for presentation of the interior portion 160 may be synchronized with the exterior portion 180 of the content 134. For example, a visual effect of the interior portion 160 is displayed on the internal display 162 of the vehicle 104 and may be viewable by an occupant of the vehicle 104. As with the exterior portion 180 of the content 134, the interior portion 160 of the content 134 may include any combination or number of effects including audio effects, haptic effects, vehicle motion effects, lighting effects, smell effects, weather effects (e.g., heat, cold, wind, rain, snow, fog, or the like generated by the climate control 182 of the vehicle 104 through one or more vents 184). The interior portion 160 portion of the content 134 is generally executed by a portion of the control system 176 based on instructions from the entertainment system 100. The vehicle 104 may communicate with the entertainment system 100 to provide user inputs to the entertainment system 100 configured to affect the content 134. Thus, a seamless media experience between the entertainment system 100 and the vehicle 104 is presented. The communication between the vehicle 104 and the entertainment system 100 may be transmitted via communication module 170 (discussed in further detail herein). A user input received by the control system 176 may be used by the entertainment system 100 to affect the content 134. Any portion of the control system 176 may be used for such user inputs, including, but not limited to the window control 146, brake control 148, accelerator 150, turn indicator control 154, wiper control 156, etc.

In one specific example, shown in FIGS. 4 and 5, the display system 130 displays safari animals, while the sound generator of the entertainment system 100 and/or the audio system 186 of the vehicle 104 plays related animal sounds. The internal display 162 of the vehicle 104 may display an interior portion 160 of the content 134 such as additional information related to an animal displayed on the display system 130. The internal display 162 may display instructions to the user to prompt the user to interact with the content 134 using the vehicle 104 control system 176, such as “Welcome to the safari. Use the car controls to drive toward an animal for a closer view.” As the user uses the vehicle 104 controls such as the brake control 148, the accelerator 150, and/or the steering wheel 144 to drive toward an animal, the base 110 may provide acceleration/deceleration or haptic effects to the vehicle 104. For example, in response to the user pressing on the accelerator 150, the control system 176 may send a signal to the entertainment system 100 that the accelerator 150 has been pressed, including the speed and/or depth of the pedal depression. In response to the signal from the vehicle 104, the base 110 may tilt the vehicle 104 backward to simulate acceleration. Similarly, the base 110 may vibrate to simulate driving over a bumpy road or the bare ground. As the user turns the steering wheel 144, the vehicle 104 may send signals to the entertainment system 100 indicating the angle, direction, and/or rate of turning of the steering wheel 144 and the display system 130 may pan the content 134 accordingly to simulate left and right turns of the vehicle 104. Similarly, if the user presses the brake control 148, the vehicle 104 may send a signal to the entertainment system 100 indicating the speed and/or depth of the brake pedal compression and the entertainment system 100 may cause the base 110 to tilt forward, simulating deceleration of the vehicle 104. In another example, an animal may appear to charge the vehicle 104 and ram it. The base 110 may transmit haptic vibrations, tilt, raise, or lower the vehicle 104 to simulate the animal ramming the vehicle 104. As an animal appears to ram the vehicle 104, the sound system in the vehicle 104 and/or entertainment system 100 may play crashing sounds, activate lights, display a visual effect of on wither the internal display 162, the external display 108, or the like.

In some examples, two or more vehicles 104 may experience a similar content 134 substantially concurrently (e.g., the content 134 may be synchronized between two or more entertainment systems 100). Thus, the entertainment system 100 may present content 134 with a social or gaming aspect. For example, two or more vehicles 104 in communication with respective entertainment systems 100 may experience content 134 in a form of a multi-player game or puzzle (e.g., escape room) environment, in which the control system 176 of the vehicles 104 take the place of, or supplement, a traditional gaming controller. The respective entertainment systems 100 may be located in proximity to one another, such as in a cluster, or may be distant from one another such as in another part of the country or world. In one example, the occupants of the vehicles 104 may play respective roles in the game environment and the entertainment system 100 may display a representation of one user and/or vehicle (e.g., a digital twin) to another user and/or vehicle. For example, occupants of respective vehicles may be entered into a virtual car race against one another and/or simulated vehicles, and the content 134 may include images of the vehicles 104 passing one another, or projected behind a vehicle 104 such that a competing vehicle appears on the external display 108 and is visible in a rear view mirror. In some examples, the entertainment system 100 may present content 134 and a different entertainment system, such as a gaming console, an occupant device such as a tablet computer, phone, smart watch, fitness tracker, virtual reality display, augmented reality display, or head mounted display, may also present the content 134 substantially concurrently (e.g., synchronized for two or more users inside or outside the vehicle 104). The different entertainment system may be proximate to the entertainment system 100 (e.g., a user device in the vehicle 104) or may be distant from the entertainment system 100 (e.g., a gaming console in another country). Continuing the multi-player game example above, the entertainment system 100 may present content 134 simulating a car race, while a gaming console remote from the entertainment system 100 may also present the content 134 car race such that the vehicle 104 occupant and the user of the remote gaming console can both participate in the race. The entertainment systems 100 and/or other entertainment systems may be in communication with one another via the communication module 170 directly or via a network such as the internet, or another network external to the entertainment system 100.

In some examples, a duration and/or subject matter of the content 134 is based on a user preference. For example, the entertainment system 100 may present a list of available content 134 from a menu displayed on an occupant device (such as a phone, smart watch, fitness tracker, tablet, laptop, etc.), an internal display 162 of the vehicle 104, and/or on the external display 108, and the user may select the content 134 to be presented via one or more of these devices. The menu may be part of a reservation or booking system generated by a processing element that enables a user to reserve the entertainment system 100 for use. Some examples of content available for selection from the menu may include a “charging ride”, a long-term event such as a football, soccer, basketball, hockey, or other sports game, or even an extended stay where the entertainment system 100 offers a natural, relaxing setting including effects such as meteor showers, elephants sleeping, lions on the prowl, etc. Additionally or alternately, the content 134 may be based on an estimated charging time of the vehicle 104 by the charging device 106. For example, if the charging device 106 estimates that the vehicle 104 will take 2 hours to reach a desired battery state of charge, the entertainment system 100 may select, or offer for selection, content 134 with a duration of about 2 hours. In another example, the entertainment system 100 may select, or offer for selection, content 134 based on a charging time as well as a user preference. For example, if the estimate charging time of the vehicle 104 is 2 hours, and a user would like to have 30 minutes for another activity, such as shopping, the entertainment system 100 may select, or offer for selection, content 134 with a duration of 90 minutes, enabling the user to experience the content 134 and have 30 minutes for shopping. A user may be able to modify the duration of the content 134 at any time before or during the display of the content. In some examples, the entertainment system 100 may modify the content 134 to adapt to the user duration preference or estimated charge time. For example, if a selected content 134 has a duration of 2 hours and the vehicle 104 is estimated to be charged in 90 minutes, the entertainment system 100 may remove scenes from the content 134 or adjust playback speed to fit the time allocated. The content 134 may include suggestions of activities for the user to engage in nearby, but outside the vehicle 104.

In some examples, the content 134 may be based on a type of vehicle 104. For example, the entertainment system 100 may include a sensor such as a camera that acquires an image of the vehicle 104 and a processing element 166 that can determine the type of vehicle 104 from the image. For example, the entertainment system 100 may capture an image of, or scan, a vehicle identification number (“VIN”) that identifies one or more aspects of the vehicle, such as the make, model year, etc. The entertainment system 100 may, based on the identified vehicle, determine or retrieve from memory, other aspects of the vehicle such as seat configuration, ride height, wheelbase, number of seats, number of doors, configuration of internal and externa lights, etc. In another example, the vehicle 104 may identify itself via electronic communications with the entertainment system 100. The content 134 may be adapted for specific kinds of vehicles 104, including as identified by the entertainment system 100. The entertainment system 100 may generate bespoke content 134 for a particular vehicle or type of vehicle. For example, if a vehicle 104 that does not enable external control or interface with its control system 176 is used, the content 134 may be limited types of content that do not use features of the control system 176. Similarly, if a vehicle 104 is of a type that does enable external interfacing with its control system, the content 134 may include the ability to make use of such features. In another example, the content 134 may be adapted based on an estimated or measured user line of sight based on a height of the vehicle 104. For example, the content 134 may be presented lower on the external display 108 and/or internal surface 188 for a sedan than for a truck.

In some examples, the entertainment system 100 may offer items for sale to a user via the content 134. For example, the entertainment system 100 may offer food to be delivered to the vehicle 104. In some examples, the content 134 may be paused and the vehicle 104 moved away from, or out of, the structure 102 such as to receive a food order, or the like. The vehicle 104 may re-enter the structure 102 and the content 134 may resume. In some examples, the content 134 may be interrupted if the entertainment system 100 detects that a user has exited the vehicle 104 (e.g., either through a sensor such as one or more of: a camera, light detection and ranging (LIDAR), sound navigation and ranging (SONAR), laser, photogrammetric array, or the like) associated with the structure 102, a microphone that detects a door closure, or a sensor of the control system 176 of the vehicle 104 (e.g., a door ajar sensor). For example, it may be desired to pause the tilting or haptic effects (if used) of the base 110 if a user exits the vehicle 104. In another example, the entertainment system 100 may offer items for sale that are related to the content 134, such as a toy, doll, virtual item, or the like. In some examples, an item offered for sale may be authenticated with a non-fungible token, particularly when the item is a virtual item or game content. In some examples, the vehicle 104 may act as a wallet for non-fungible tokens.

In some examples, the content 134 may be adapted to promote user alertness, such as by presenting a fitness routine for the user to follow. For example, control system 176 and/or entertainment system 100 may include a biometric sensor or internal camera and may be adapted to assess the alertness of a driver. In response to determining that the driver appears to be tired or drowsy, the entertainment system 100 may include user activity prompts (e.g., “Why not get out and stretch?”) in the content 134.

In some examples, the content 134 may include a virtual concierge configured to assist a vehicle occupant with food ordering, hotel check-in, flight or other travel arrangements. The entertainment system 100 may contact service providers on behalf of the vehicle occupant to request such services.

In some examples, information may be presented over or with the content 134. For example, the entertainment system 100 may display a remaining charging time for the vehicle 104 on the external display 108 and/or internal display 162 or may make an announcement over the vehicle 104 or entertainment system 100 sound system. In some examples, the information may be integrated with the content 134 such as by being displayed on virtual signage in the content 134. The information may be related to a location, planned route, or destination of the vehicle 104. For example, the information may be localized and include special deals, promotions, points of interest, traffic, waypoints, etc. along a planned vehicle 104 route or destination.

FIG. 6 illustrates a simplified block diagram for the various devices of the entertainment system 100, the control system 176, or other portions of the vehicle 104. As shown, the various devices may include one or more processing elements 166, a display 178, one or more memory components 168, a communication module 170, a power supply 172, and an optional input/output (I/O), where the various components may be in direct or indirect communication with one another, such as via one or more system buses, contract traces, wiring, or via wireless mechanisms.

The one or more processing elements 166 may be substantially any electronic device capable of processing, receiving, and/or transmitting instructions. For example, the processing elements 166 may be a microprocessor, microcomputer, graphics processing unit, or the like. It also should be noted that the processing elements 166 may include one or more processing elements or modules that may or may not be in communication with one another. For example, a first processing element 166 may control a first set of components of the computing device and a second processing element 166 may control a second set of components of the computing device where the first and second processing elements may or may not be in communication with each other. Relatedly, the processing elements 166 may be configured to execute one or more instructions in parallel locally, and/or across a network, such as through cloud computing resources.

In some embodiments, the one or more processing elements 166 may be provided by, or included in, a show control system such as a show controller. For example a show control system may be adapted to link together, synchronize, coordinate, and/or operate multiple control systems, such as the vehicle control system 176, an interior or external display, a projector, and/or other portions of the entertainment system 100 disclosed herein. The show control system may enable the generation of an integrated media experience from disparate lighting, haptic, sound, and other effect systems. The show control system may present the content based on a show script that includes timing and synchronization signals for the presentation of portions of the media. The show control system may be coupled to either an interior and/or external display to control content presented on the display. The show control system may be coupled to an in-vehicle control system 176 to control at least one vehicle system. A processing element 166 may be configured to generate or modify content to be presented on the display to coordinate the content with at least one vehicle system.

The display 178 (e.g., the external display 108 used in the display system 130 and/or internal display 162) provides an input/output mechanism the entertainment system 100 and/or control system 176 such as to display visual information (e.g., images, graphical user interfaces, videos, notifications, and the like) to a user, and in certain instances may also act to receive user input (e.g., via a touch screen, soft controls 164, or the like). The display 178 may include an LCD screen, plasma screen, LED screen, an OLED screen, reflective and/or diffusive projection surface, projector 136, or the like. Display 178 may be 2D, stereoscopic, holographic, laser, multiplanar or any display technology suitable for a particular application. The type and number of displays may vary with the type of devices (e.g., the vehicle 104, the structure 102, a user device, or the like.)

The memory component 168 stores electronic data that may be utilized by the computing devices, such as audio files, video files, document files, programming instructions, and the like. The memory component 168 may be, for example, non-volatile storage, a magnetic storage medium, optical storage medium, magneto-optical storage medium, read only memory, random access memory, erasable programmable memory, flash memory, or a combination of one or more types of memory components. In many embodiments, the entertainment system 100 may have a larger memory capacity than the control system 176 of the vehicle 104, with the memory components optionally linked via network or the like.

The communication module 170 receives and transmits data to and from the entertainment system 100 and the vehicle 104 and may transmit data to other devices such as other entertainment systems 100, user devices, gaming consoles, etc. The communication module 170 may transmit and send data directly between the entertainment system 100 and the vehicle 104, or indirectly such as through a network. For example, the communication module 170 may transmit data to and from the vehicle 104 and/or entertainment system 100 to other computing devices (e.g., other entertainment systems 100, user devices, gaming consoles, the charging device 106, the internal display 162, vehicle infotainment system, a virtual reality or augmented reality display or head-mounted display, etc.). In some embodiments, the communication module 170 may also include various sub-modules, such as an API that interfaces and translates requests between the vehicle 104 and the entertainment system 100. The communication module 170 may include any suitable wired or wireless interface. For example, the network may be an Ethernet network, Controller Area Network (“CAN”) bus, such as defined by Society of Automotive Engineers (“SAE”) specification J1939 Wi-Fi, Bluetooth, Wi-Max, Zigbee network, internet of things (“IoT”) network (e.g., a 900 MHz network), the internet, microwave link, cellular telephone network (e.g., GSM, GPRS, 4G, 5G, or the like. The communication module 170 may include, or communicate with, an onboard diagnostic II (“OBD-II”) device configured to provide the electrical communication between the entertainment system 100 and the vehicle 104 control system 176. The OBD-II device may be based on at least one of SAE specifications J1962, J1850, J2284 or ISO specifications 9141-2, 14230, or 15765, or similar standards. For example, the communication module 170 may include an OBD-II dongle that plugs into an appropriate port in the vehicle 104 to establish a wired connection to the vehicle 104 control system 176 and also communicates wirelessly (e.g., Wi-Fi) with the entertainment system 100. In some examples, the communication module 170 may include electronic communication between the vehicle 104 and the entertainment system 100 via a cable connection between the charging device 106 and the vehicle 104 (e.g., via the cable 191). In some embodiments, the network may include security features such as a firewall or a “walled garden”. As used herein, a walled garden refers to an environment that controls the user's access to network-based content and services. The walled garden directs the user's navigation within particular areas to enable access to a selection of material or prevent access to other material. The network security features may limit bad-actors from unauthorized access to the entertainment system and/or the vehicle 104. In some embodiments, a cloud network such as the internet, may be used and access provided to the entertainment system 100 from outside the “wall” but access to the vehicle 104 may be restricted or connections prevented outside the “wall”. In some embodiments, the entertainment system 100 and the vehicle 104 control system 176 may be configured such that while the entertainment system 100 can issue commands to the vehicle 104 control system 176, the control system may determine whether a command is safe to execute. Such security features may enhance the safety of the entertainment system 100. For example, while it may be possible for a bad actor to access and disrupt the content, the bad actor may be prevented or thwarted from causing the vehicle to take unsafe actions.

The various devices of the system may also include a power supply 172 such as the photovoltaic panel 112. The power supply 172 provides power to various components of the entertainment system 100 and/or the vehicle 104 (such as power to charge the vehicle 104 batteries via the charging device 106). The power supply 172 may include one or more rechargeable, disposable, or hardwire sources, e.g., batteries, power cord, AC/DC inverter, DC/DC converter, or the like. Additionally, the power supply 172 may include one or more types of connectors or components that provide different types of power to the entertainment system 100 and/or the vehicle 104. In some embodiments, the power supply 172 may include a connector (such as a CHAdeMO connector) that provides power to the vehicle 104 may also transmits data to and from the vehicle 104 and/or the entertainment system 100.

The input/output interface 174 allows the system devices to receive input from a user and provide output to a user. In some devices, for instance the entertainment system 100, the input/output interface 174 may be optional. For example, the input/output interface 174 may include a capacitive touch screen, keyboard, mouse, stylus, or the like. The type of devices that interact via the input/output interface 174 may be varied as desired. While it is desirable to repurpose available vehicle components and systems to provide an entertainment experience in accordance with the present invention, in other circumstances it may be desirable to augment the vehicle components and systems with special purpose devices that provide input/output functions that are not readily implemented by the native vehicle systems. For example, speakers, in-car lighting and displays, sensors for gesture recognition and the like might be provided by an augmentation device owned, rented or borrowed by the vehicle owner that couples to I/O interface 174 to provide augmented features.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. An entertainment system for a vehicle comprising:
a display external to the vehicle and viewable by an occupant of the vehicle;
a communication module configured to receive occupant preferences from the occupant; and
a processing element configured to generate or modify content to be presented on the display based on the occupant preferences.

2. The entertainment system of claim 1, further comprising:
a structure configured to receive the vehicle; and
a charging device configured to charge the vehicle;
wherein the display is coupled to the structure and is configured to present the content to the occupant as the charging device charges the vehicle.

3. The entertainment system of claim 1, wherein the display substantially surrounds the vehicle.

4. The entertainment system of claim 1, wherein the communication module receives data via a vehicle cable or wireless communication.

5. The entertainment system of claim 1, further comprising a sense effect system configured to provide at least one of a smell effect, a sound effect, a heat effect, a cold effect, a wind effect, or a weather effect.

6. The entertainment system of claim 1, further comprising an animatronic device configured to present a portion of content.

7. The entertainment system of claim 6, wherein the animatronic device is configured to electrically couple the charging device to the vehicle.

8. The entertainment system of claim 1, further comprising a base configured to support the vehicle and to provide at least one of a tilt effect, an acceleration effect, a deceleration effect, or a haptic effect to the vehicle.

9. The entertainment system of claim 1, further comprising an auxiliary autonomous vehicle configured to present a portion of the content.

10. The entertainment system of claim 9, wherein the auxiliary autonomous vehicle comprises at least one of an autonomous aerial vehicle, an autonomous ground-based vehicle, or a robot.

11. The entertainment system of claim 1, further comprising a communication system in electrical communication with a control system of the vehicle, wherein:
the communication system is configured to transmit a signal to the vehicle, and
based on the signal, the control system is configured to present a portion of the content.

12. The entertainment system of claim 11, wherein the communication system is configured to activate a portion of the control system in synchronization with the content.

13. The entertainment system of claim 11, wherein the control system is configured to receive an input from the occupant, wherein the input causes a change in the content.

14. The entertainment system of claim 11, comprising an onboard diagnostic II (“OBD-II”) device configured to provide the electrical communication between the communication system and the control system.

15. The entertainment system of claim 1, wherein the content is configurable by an occupant device.

16. The entertainment system of claim 1, wherein the content comprises a game or a puzzle.

17. A system comprising two or more of the entertainment system of claim 17, wherein the content comprises a game configured to enable occupants of respective vehicles received in the two or more entertainment systems to participate together.

18. An entertainment system for a vehicle comprising:
one or more processing elements;
one or more computer-readable non-transitory storage media, the media encoded with instructions that when executed cause the one or more processing elements to perform operations comprising:
displaying content on a display external to the vehicle and viewable by an occupant of the vehicle;
receiving occupant preferences from the occupant;
modifying the content based on the occupant preferences; and
displaying the modified content.

19. A method of providing content to a vehicle comprising:
displaying, via one or more processing elements, content on a display external to the vehicle and viewable by an occupant of the vehicle;
receiving, via the one or more processing elements, occupant preferences from the occupant;
modifying, via the one or more processing elements, the content based on the occupant preferences to generate modified content; and
displaying, via the one or more processing elements, the modified content.

20. An entertainment system for a vehicle comprising:
a display external to the vehicle and viewable by an occupant of the vehicle;
a show control system coupled to the display to control content presented on the display, and coupled to an in-vehicle control system to control at least one vehicle system; and
a processing element configured to generate or modify content to be presented on the display to coordinate the content with the at least one vehicle system.
